(19) United States
(12) Patent Application Publication
(10) Pub. No.: US 2012/0069860 A1
(43) Pub. Date: Mar. 22, 2012

(54) Gain-Switched Fiber Laser

(75) Inventors: Eran Inbar, Tel Aviv (IL); Michael Katz, Tel Aviv (IL)

(73) Assignee: V-GEN LTD., Tel Aviv (IL)

(21) Appl. No.: 13/132,655

(22) PCT Filed: Dec. 2, 2009
(86) PCT No.: PCT/IL2009/001136

§ 371 Date: Nov. 28, 2011

Related U.S. Application Data
(60) Provisional application No. 61/119,466, filed on Dec. 3, 2008.
(60) Provisional application No. 61/262,178, filed on Nov. 18, 2009.

(51) Int. Cl. H01S 3/067

(52) U.S. Cl. 372/6

(57) ABSTRACT

Pulsed fiber laser including an electronic driver, a laser diode and a laser cavity, the laser cavity including a combiner, a doped optical fiber and a coupler, the laser diode being coupled with the electronic driver, the combiner being coupled with the laser diode, the doped optical fiber being coupled with the combiner, and the coupler being coupled with the doped optical fiber and the combiner, the electronic driver for providing a drive current, the laser diode for generating a pump pulse, the doped optical fiber for absorbing the pump pulse and for generating a circulating laser pulse, the coupler for outputting a first portion of the circulating laser pulse and for returning a second portion of the circulating laser pulse to the combiner, wherein the electronic driver operating the laser diode at a specific pump pulse repetition rate (PRR), a specific pump pulse shape and a specific pump pulse width and wherein the combiner providing the pump pulse and the second portion of the circulating laser pulse to the doped optical fiber.

### FIELD OF THE DISCLOSED TECHNIQUE

The disclosed technique relates to fiber lasers, in general, and to methods and systems for constructing pulsed fiber lasers using gain switching, in particular.

### BACKGROUND OF THE DISCLOSED TECHNIQUE

Fiber lasers are lasers in which optical fibers are used as the gain media for the laser. The fibers can be made of glass or plastic. The optical fibers used in such lasers are usually doped using rare-earth metals such as neodymium, ytterbium, erbium or thulium and have applications in many fields, such as material processing, telecommunications, spectroscopy and medicine. Fiber lasers can be mode-locked and Q-switched for generating laser pulses on the order of nanoseconds, picoseconds and femtoseconds. Such lasers are known in the art.

U.S. Pat. No. 7,120,174 to MacCormack, et al. entitled, “Pulsed laser apparatus and method” is directed towards a laser apparatus for generating optical pulses. The laser apparatus has a reflecting gain element which includes a fiber gain medium. The reflecting gain element is coupled to a controllable reflecting/transmitting module having a reflecting state and a transmitting state. The controllable reflecting/transmitting modules are operable to switch from the transmitting state to the reflecting state to initiate a build-up of an optical pulse, and to switch back to the transmitting state for outputting the optical pulse before it reaches the reflecting/transmitting module after a cavity roundtrip. MacCormack also discloses a method for generating optical pulses by Q-switching. The method comprises a first step of providing a reflective gain element comprising a first reflective means, an input/output port and a gain medium therebetween. An optical pumping means is also provided for pumping radiation into the gain medium for enabling optical gain and for emitting optical radiation from the input/output port along a first optical path. In a second step, a controllable reflecting/transmitting means is provided and disposed in the first optical path. The controllable reflecting/transmitting means has a reflecting state for reflecting a controllable portion of the optical radiation back into the gain medium and a transmitting state for transmitting the optical radiation through the reflecting/transmitting means along the first optical path to form an output optical radiation. The controllable reflecting/transmitting means is also operable to switch between the reflecting state and the transmitting state. In a third step, the controllable reflecting/transmitting means is switched from the transmitting state to the reflecting state. This switching forms a temporal optical cavity between the first reflective means and the controllable reflective/transmitting means through the gain medium. The temporal optical cavity is formed for a duration of time less than the time required for the controllable portion of the optical radiation to make a roundtrip and to initiate an optical pulse. In a fourth step, the controllable reflecting/transmitting means is switched from the reflecting state to the transmitting state for transmitting the optical pulse propagating from the gain element through the controllable reflecting/transmitting means along the first optical path.

US Published Patent Application No. 2006/0045145 to Arahira, entitled, “Mode-locked laser diode device and wavelength control method for mode-locked laser diode device” is directed towards a laser for generating optical pulses in which the wavelength width in the wavelength's variable area is sufficiently wide and in which frequency chirping is suppressed enough to be used for optical communication systems. The laser is constructed from an optical pulse generation section which includes a mode-locked laser device, a continuous wave light source, a first optical coupling means and a second optical coupling means. An optical waveguide, which includes an optical gain area, an optical modulation area and a passive wave-guiding area, is created in the mode-locked laser device. Constant current is injected into the optical gain area from a first current source via a p-side electrode and an n-side common electrode. Reverse bias voltage is applied to the optical modulation area by a voltage source via a p-side electrode and an n-side common electrode. The modulation voltage, having a frequency obtained by multiplying the cyclic frequency of the resonator of the mode-locked laser device by a natural number, is applied to the optical modulation area by a modulation voltage source. The output light of the continuous wave light source is inputted to the optical wave guide of the mode-locked laser device via the first optical coupling means, and the output light of the mode-locked laser device is outputted to the outside via the second optical coupling means.

U.S. Pat. No. 6,400,495 to Zayhowski, entitled, “Laser system including passively Q-switched laser and gain-switched laser” is directed towards a two-stage laser system including a passively Q-switched microchip laser and a gain-switched microchip laser. A pulse train generated by the passively Q-switched laser is fed into the gain-switched laser, which in turn produces an optical output signal at a preferred wavelength. In particular, the passively Q-switched laser is pumped with an optical signal generated by a diode pump laser. Based on the absorption of the optical signal, energy in the passively Q-switched laser then accumulates in its optical cavity until a threshold is reached. At this point an output optical pulse is produced and then fed into the gain-switched laser. In turn, energy accumulates in the optical cavity of the gain-switched laser where the gain medium absorbs the optical pulse from the Q-switched laser. As a result, light from the optical pulse efficiently inverts the transition near a second wavelength. This results in a gain in the gain-switched cavity at the second wavelength. By choosing an appropriate output coupler on the gain-switched laser, the gain induced by the absorbed pulse leads to the development of an optical pulse at the second wavelength. Preferably, the output pulse at the second wavelength is at around 1.5 μm, which is an eye-safe wavelength.

### SUMMARY OF THE PRESENT DISCLOSED TECHNIQUE

It is an object of the disclosed technique to provide a novel system for a fiber laser setup for generating laser pulses based on the method of gain switching which overcomes the disadvantages of the prior art. In accordance with the disclosed technique, there is thus provided a pulsed fiber laser including an electronic driver, a laser diode, and a laser cavity, the laser cavity including a combiner, a doped optical fiber, and a coupler. The laser diode is coupled with the electronic driver, the combiner is coupled with the laser diode, the doped optical fiber is coupled with the combiner, and the coupler is coupled with the doped optical fiber and the combiner. The electronic driver is for providing a drive current, the laser diode is for generating a pump pulse, the doped optical fiber is for absorbing the pump pulse and for generating a circulating laser pulse and the coupler is for outputting a first portion of the circulating laser pulse and for returning a second portion of the circulating laser pulse to the combiner. The electronic driver operates the laser diode at a specific pump pulse repetition rate (PRR), a specific pump pulse shape and a specific pump pulse width and the combiner provides the pump pulse and the second portion of the circulating laser pulse to the doped optical fiber.

In accordance with another aspect of the disclosed technique, there is thus provided a pulsed fiber laser including an electronic driver, a laser diode, and a laser cavity, the laser cavity including a doped optical fiber and a coupler. The laser diode is coupled with the electronic driver, the doped optical fiber is coupled with the laser diode, and the coupler is coupled with a first side of the doped optical fiber and a second side of the doped optical fiber. The electronic driver is for providing a drive current, the laser diode is for generating a pump pulse, the doped optical fiber is for absorbing the pump pulse and for generating a circulating laser pulse, and the coupler is for outputting a first portion of the circulating laser pulse and for returning a second portion of the circulating laser pulse to the second side of the doped optical fiber. The electronic driver operates the laser diode at a specific pump pulse repetition rate (PRR), a specific pump pulse shape and a specific pump pulse width, and the pump pulse and the second portion of the circulating laser pulse are provided to the second side of the doped optical fiber.

In accordance with a further aspect of the disclosed technique, there is thus provided a pulsed fiber laser including a plurality of electronic drivers, a plurality of laser diodes, and a laser cavity, the laser cavity including a plurality of combiners, a doped optical fiber, and at least one coupler. Each one of the plurality of laser diodes is coupled with a respective one of the plurality of electronic drivers and each of one the plurality of combiners is coupled with a respective one of the plurality of laser diodes. The doped optical fiber is coupled with each of the plurality of combiners, and the coupler is coupled with a first one of the plurality of combiners and with a second one of the plurality of combiners. Each one of the plurality of electronic drivers is for providing a respective drive current and each one of the plurality of laser diodes is for generating a respective pump pulse. The doped optical fiber is for absorbing each of the respective pump pulses and for generating a circulating laser pulse. The coupler is for outputting a first portion of the circulating laser pulse and for returning a second portion of the circulating laser pulse to one of the plurality of combiners. The plurality of electronic drivers respectively operate the plurality of laser diodes at specific pump pulse repetition rates (PRRs), specific pump pulse widths and specific pulse shapes. The plurality of combiners provide the respective pump pulses and the second portion of the circulating laser pulse to the doped optical fiber.

In accordance with another aspect of the disclosed technique, there is thus provided a pulsed fiber laser including an electronic driver, a laser diode, and a laser cavity, the laser cavity including a combiner, a doped optical fiber, a circulator, and a fiber Bragg grating (FBG). The laser diode is coupled with the electronic driver, the combiner is coupled with the laser diode, the doped optical fiber is coupled with the combiner, the circulator is coupled with the doped optical fiber and the combiner, and the FBG is coupled with the circulator. The electronic driver is for providing a drive current, the laser diode is for generating a pump pulse and the doped optical fiber is for absorbing the pump pulse and for generating a circulating laser pulse. The circulator provides the circulating laser pulse to the FBG and the FBG outputs a first portion of the circulating laser pulse and returns a second portion of the circulating laser pulse to the circulator. The circulator provides the second portion of the circulating laser pulse to the combiner. The electronic driver operates the laser diode at a specific pump pulse repetition rate (PRR), a specific pump pulse width and a specific pump pulse shape, and the combiner provides the pump pulse and the second portion of the circulating laser pulse to the doped optical fiber.

In accordance with a further aspect of the disclosed technique, there is thus provided a pulsed fiber laser including a first electronic driver, a laser diode, and a laser cavity, the laser cavity including a combiner, a doped optical fiber, a high reflection fiber Bragg grating (HRFBG), and a low reflection fiber Bragg grating (LRFBG). The laser diode is coupled with the first electronic driver, the combiner is coupled with the laser diode, the doped optical fiber is coupled with the combiner, the HRFBG is coupled with the combiner, and the LRFBG is coupled with the doped optical fiber. The first electronic driver is for providing a drive current, the laser diode is for generating a pump pulse and the doped optical fiber is for absorbing the pump pulse and for generating a circulating laser pulse. The HRFBG is for reflecting the pump pulse and the LRFBG is for outputting a first portion of the circulating laser pulse and for returning a second portion of the circulating laser pulse to the combiner. The combiner provides the pump pulse and the second portion to the HRFBG and the first electronic driver operates the laser diode at a specific pump pulse repetition rate (PRR), specific pump pulse width and a specific pulse shape.

### BRIEF DESCRIPTION OF THE DRAWINGS

The disclosed technique will be understood and appreciated more fully from the following detailed description taken in conjunction with the drawings in which:

FIG. 1A is a schematic illustration showing a pulsed fiber laser setup including a single laser pump, constructed and operative in accordance with an embodiment of the disclosed technique;

FIG. 1B is a schematic illustration showing a pulsed fiber laser setup including a plurality of laser pumps, constructed and operative in accordance with another embodiment of the disclosed technique;

FIG. 2A is a schematic illustration showing a pulsed fiber laser setup including an isolator, constructed and operative in accordance with a further embodiment of the disclosed technique;

FIG. 2B is a schematic illustration showing a pulsed fiber laser setup including a band pass filter, constructed and operative in accordance with another embodiment of the disclosed technique;

FIG. 2C is a schematic illustration showing a pulsed fiber laser setup including a band pass filter and a reflective mirror, constructed and operative in accordance with a further embodiment of the disclosed technique;

FIG. 2D is a schematic illustration showing a pulsed fiber laser setup including a circulator and a fiber Bragg grating, constructed and operative in accordance with another embodiment of the disclosed technique;

FIG. 2E is a schematic illustration showing a pulsed fiber laser setup including two fiber Bragg gratings, constructed and operative in accordance with a further embodiment of the disclosed technique;

FIG. 2F is a schematic illustration showing a pulsed fiber laser setup including a saturable absorber, constructed and operative in accordance with another embodiment of the disclosed technique;

FIG. 2G is a schematic illustration showing a pulsed fiber laser setup including an electronic controller, constructed and operative in accordance with a further embodiment of the disclosed technique;

FIG. 2H is a schematic illustration showing a pulsed fiber laser setup including an optical fiber mirror and a coupler, constructed and operative in accordance with another embodiment of the disclosed technique; and

FIG. 3 is a schematic illustration showing a pulsed fiber laser setup including a fiber amplifier, constructed and operative in accordance with a further embodiment of the disclosed technique.

### DETAILED DESCRIPTION OF THE EMBODIMENTS

The disclosed technique overcomes the disadvantages of the prior art by providing a novel fiber laser setup for generating laser pulses based on the method of gain switching. According to the disclosed technique, the gain medium of the fiber laser is pumped by a semiconductor laser diode having a repetition rate and pulse duration which are electronically controlled. The laser cavity of the fiber laser is formed by a partial feedback of the stimulated radiation of the laser back into the gain medium. As a convention, the terms “radiation,” “laser radiation,” “laser light,” “laser beam,” “photons,” “laser pulse,” “pulse,” “stimulated emissions” and “stimulated radiation” are used interchangeably throughout the specification to denote the light produced by the fiber laser of the disclosed technique. Also, the terms “fiber” and “optical fiber” are used interchangeably throughout the specification to denote an optical fiber.

Lasers usually comprise an optical cavity, also known as an optical resonator, in which radiation can circulate, as well as a gain medium, positioned inside the optical cavity, for amplifying the radiation. The gain medium represents a substance, such as a compound, in a particular state of matter (i.e., solid, liquid, gas or plasma) which can amplify the radiation in the optical cavity. In fiber lasers, the optical cavity is usually an optical fiber. A part of the optical fiber is usually doped with an element or compound, such as a rare-earth metal or a compound of rare-earth metals, to form the gain medium of the laser.

In general, the sub-atomic particles of a substance, such as the gain medium of a laser, remain in a low energy state, known as the ground state. If energy is applied to a substance, these sub-atomic particles can absorb the energy and move to a higher energy state, known as an excited state. In a laser, the act of supplying energy to the gain medium is known as pumping the gain medium. The energy source can be referred to as a pump source, a laser pump or simply a pump. As the gain medium is pumped, a population inversion begins to occur. Population inversion refers to the amount of sub-atomic particles in the gain medium in an excited state versus the amount of sub-atomic particles in the gain medium in the ground state. It is noted that the particles in the gain medium which can be excited can also be generally referred to as active atoms or ions.

Some of the excited sub-atomic particles return to their ground state energies via a process known as spontaneous emission. As these sub-atomic particles return to their ground state, they release their stored energy as photons. If a photon passes another sub-atomic particle in a particular excited state, it can induce that sub-atomic particle to also release its stored energy in the form of a photon. This process is referred to as stimulated emission. As mentioned above, lasers usually have an optical cavity for circulation radiation, or laser light. As photons are initially released, they circulate, or reflect, inside the optical cavity of the laser, thereby inducing many sub-atomic particles in the gain medium to release their energy as photons. Usually the optical cavity is arranged such that a portion of the photons circulating inside the cavity is released via an output coupler, leading to the emission of laser light.

The gain of a laser refers to the amount of amplification, i.e., the amount of stored energy in the excited states of the sub-atomic particles of the gain medium. It is noted that without sufficient gain, the laser radiation would dissipate as it circulates inside the optical cavity. In this respect, the optical cavity can be said to have energy losses, or laser losses. When the gain is substantially equal to the laser losses, the gain medium is said to be at the lasing threshold. Any increase in the population inversion above the lasing threshold will result in sustainable amplification, which will result in laser light being produced. The lasing threshold can be maintained continuously thereby yielding a continuous wave (CW) laser. The lasing threshold can also be maintained for short durations of time using various known techniques in the art, thereby yielding a pulsed laser.

The wavelength of light emitted from a laser is usually determined by the excited states of the sub-atomic particles of the gain medium. Photons having different wavelengths can be released when the sub-atomic particles return to their ground state, depending on which excited state the sub-atomic particles were at. In the art, the wavelength dependence of the gain coefficient (i.e., the emission) of the gain medium is specified via the emission cross-section spectral line. Correspondingly, the wavelength dependence of the pump absorption coefficient is specified via the absorption cross-section.

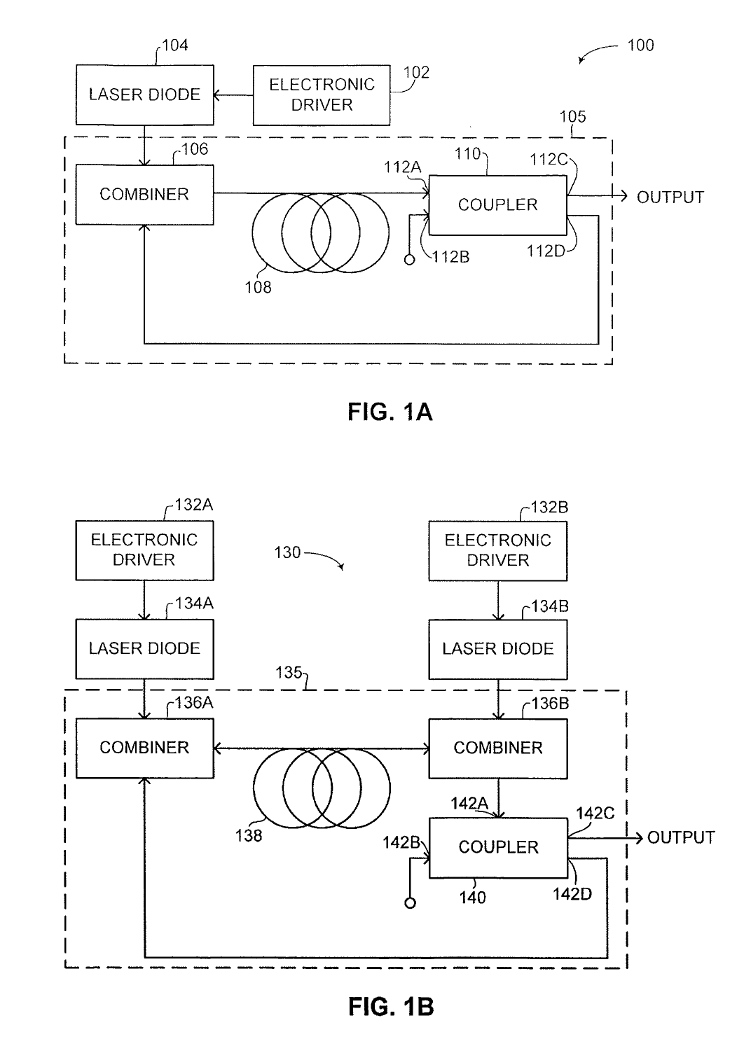

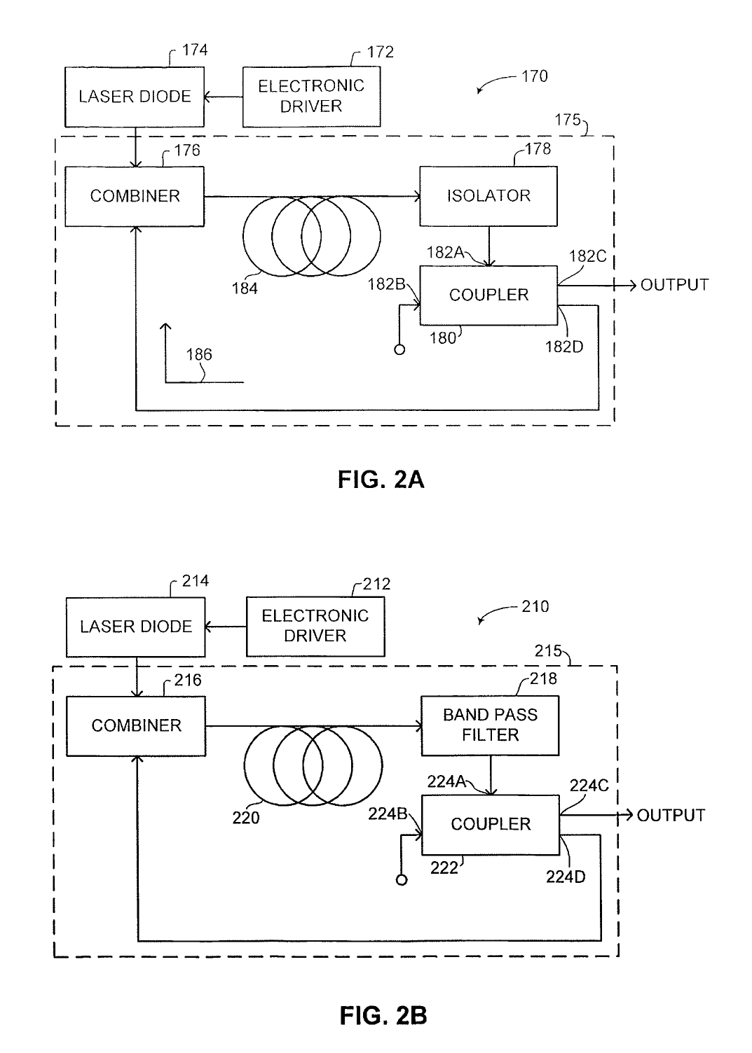

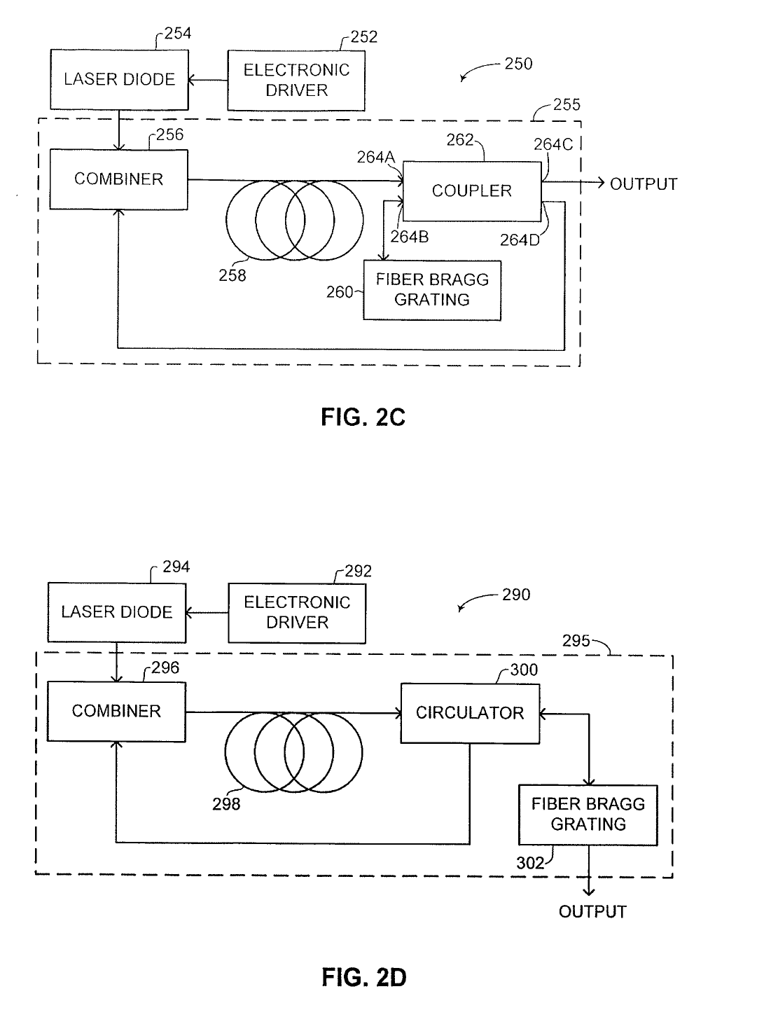

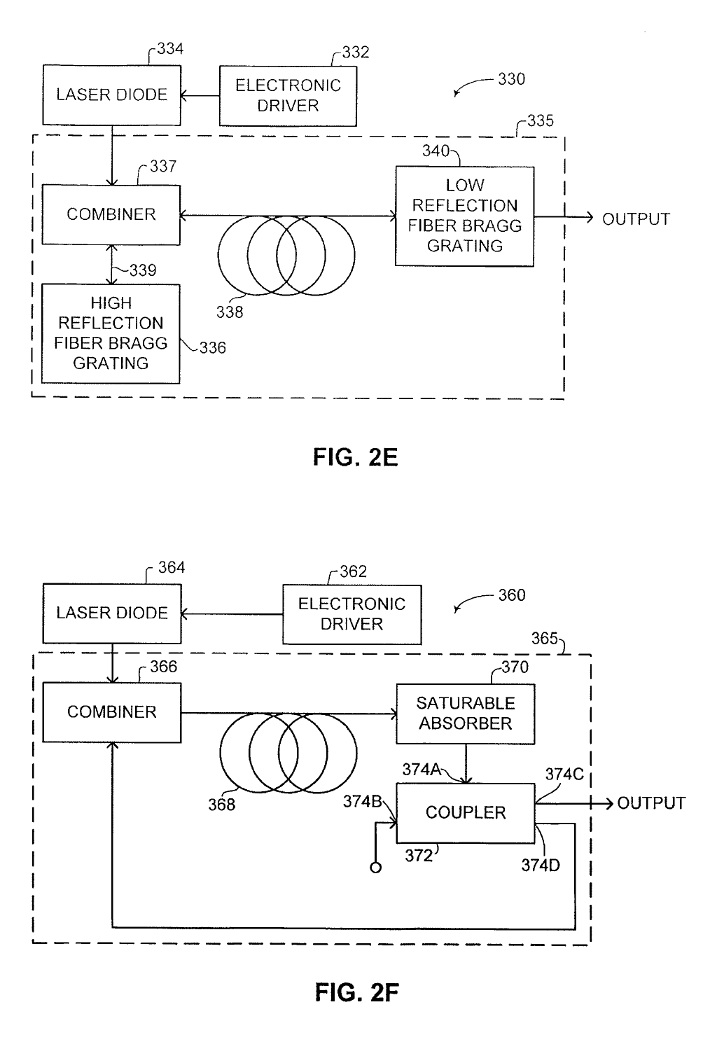

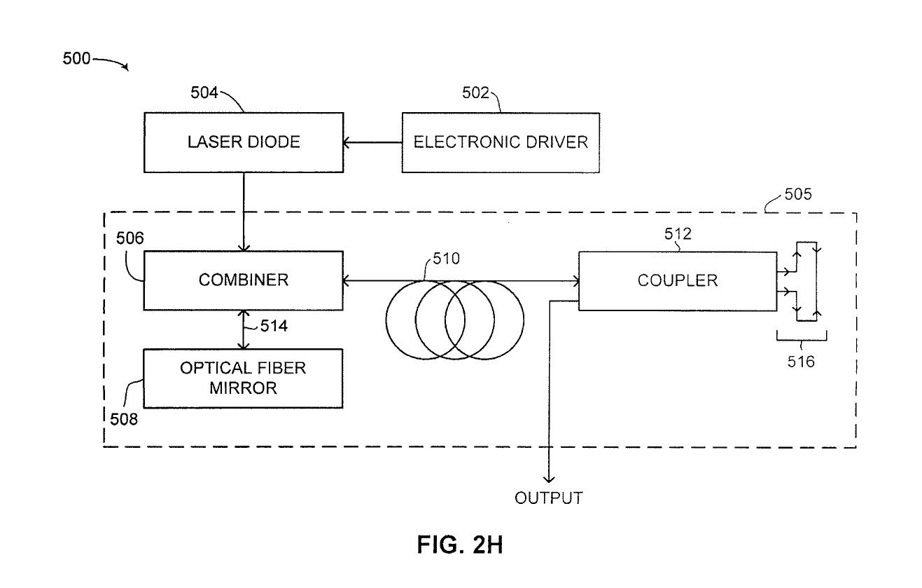

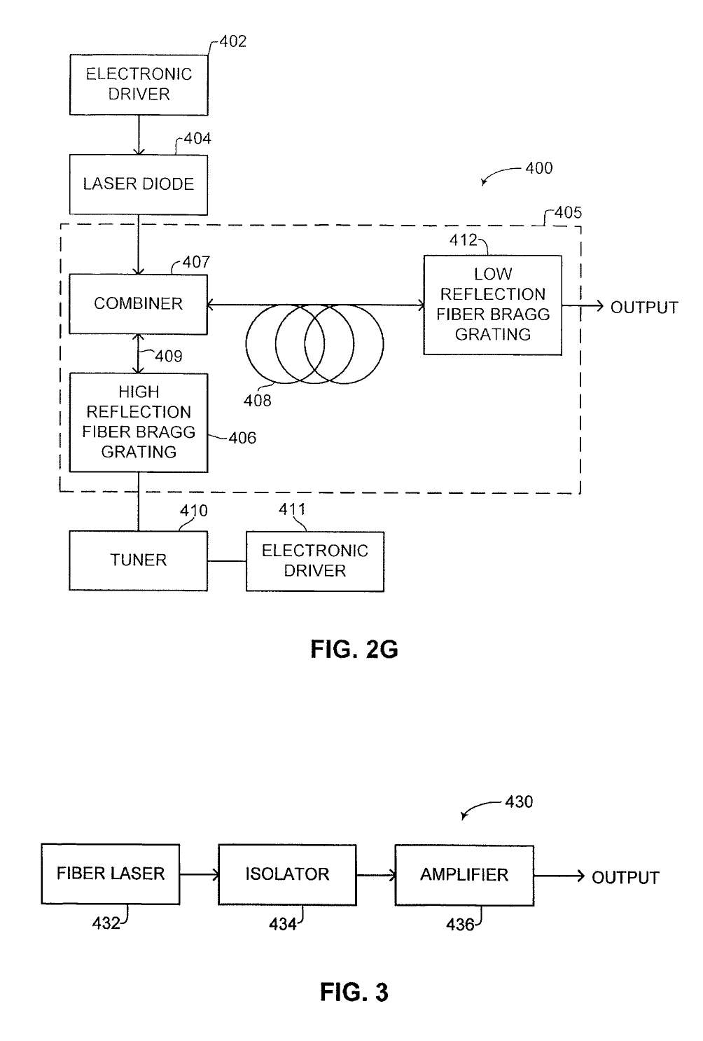

Reference is now made to FIG. 1A, which is a schematic illustration showing a pulsed fiber laser setup including a single laser pump, generally referenced 100, constructed and operative in accordance with an embodiment of the disclosed technique. Fiber laser 100 includes an electronic driver 102, a laser diode 104 and a laser cavity 105. Laser cavity 105 includes a combiner 106, a doped optical fiber 108 and a coupler 110. Coupler 110 includes two input ports 112A and 112B and two output ports 112C and 112D. Electronic driver 102 is coupled with laser diode 104. Laser diode 104 is coupled with laser cavity 105 via combiner 106. Combiner 106 is coupled with input port 112A of coupler 110 via doped optical fiber 108. Coupler 110 is coupled with combiner 106 via output port 112D. In this embodiment of the disclosed technique, input port 112B is not coupled with another element or component. In other embodiments of the disclosed technique, such as in the embodiment described below in FIG. 2C, input port 112B is coupled with another element. It is noted that coupler 110 can have a standard 2×2 port configuration. Coupler 110 can also be custom designed as described further below. Output port 112C outputs the laser light produced by fiber laser 100. Output port 112C can be coupled with an output fiber (not shown). Doped optical fiber 108 can also be referred to as a gain fiber.

Laser diode 104 can be a semiconductor laser diode. Combiner 106 can be substituted for any known pump coupler. It is noted that in one embodiment of the disclosed technique, fiber laser 100 can be constructed without a combiner. In such an embodiment, laser diode 104 can be coupled directly to doped optical fiber 108 by fusion or adhesion, with the optical fiber coupled with output port 112D also being fused or adhered to doped optical fiber 108 directly. It is noted that all the components in fiber laser 100 are coupled via optical fibers. It is also noted that the optical fibers in cavity 105, including doped optical fiber 108, can be polarization maintaining optical fibers, and that combiner 106 and coupler 110 can be polarization maintaining components. Doped optical fiber 108 is doped with an active, rare-earth element, which can include, but is not limited to, ytterbium (Yb), erbium (Er), erbium-ytterbium (Er-Yb), Thulium (Tm), Neodymium (Nd) and Germanium (Ge). In one embodiment of the disclosed technique, doped optical fiber 108 is a double-clad fiber having a single mode core. In this embodiment, laser diode 104 is coupled with combiner 106 using known pump coupling techniques. In this embodiment, fiber laser 100 produces a higher power output laser beam. In another embodiment of the disclosed technique, doped optical fiber 108 is a single-clad fiber. In this embodiment, combiner 106 is substituted for a wavelength division multiplexing (WDM) coupler and laser diode 104 is coupled to laser cavity 105 via the WDM coupler. It is noted that in this embodiment, the wavelength of the laser light produced by laser diode 104 and the wavelengths at which the WDM coupler operates must be substantially similar.

Electronic driver 102 operates laser diode 104 by providing laser diode 104 with a drive current. Electronic driver 102 can operate laser diode 104 at specific pulse repetition rates (PRR) and can operate laser diode 104 to produce specific pulse shapes, such as a square shape, sawtooth shape and the like, as is known in the art. In general, electronic driver 102 operates laser diode 104 to give off pulses in the microsecond (μs) range. The drive current of electronic driver 102 may be modified to produce different types of pulse shapes in laser diode 104. In general, the modification of the drive current depends on the specific response of laser diode 104, e.g. the permitted electronic rise time, as well as the desired effect on features of the pulse shape, such as symmetry, power residing in the tail of the pulse, and the like. Laser diode 104 acts as a pump laser for pumping doped optical fiber 108. In general, laser diode 104 operates at a wavelength corresponding to the absorption spectrum of doped optical fiber 108. Laser diode 104 can operate at a frequency, or PRR of kilohertz, tens of kilohertz or up to hundreds of kilohertz, having an output peak power of tens of watts, for example, 10 to 30 watts, or as high as hundreds of watts. It is noted that the output peak power of laser diode 104 in the disclosed technique, operating in a pulsed mode, may be higher than the output peak power of laser diode 104 operating in a continuous wave (CW) mode, since the operational duty cycle of laser diode 104 in the disclosed technique is less than 100%.

As a pump laser, laser diode 104 provides a pump pulse to laser cavity 105 via combiner 106. It is noted that in this embodiment, laser diode 104 pumps doped optical fiber 108 from the left hand side. In another embodiment, the combiner may be situated on the right hand side of doped optical fiber 108, such that laser diode 104 pumps the gain fiber from the right hand side. The pump pulse is provided by combiner 106 to doped optical fiber 108, which is used to pump doped optical fiber 108. The pump pulse generated by laser diode 104 is absorbed by doped optical fiber 108. Recall that doped optical fiber 108 represents the gain medium of fiber laser 100. Laser diode 104 pumps doped optical fiber 108 thereby causing a population inversion, which leads to stimulated radiation in doped optical fiber 108 to be produced. The stimulated radiation is provided to coupler 110 via input port 112A. A portion of the stimulated radiation is outputted from coupler 110 via output port 112C whereas the remaining portion of the stimulated radiation is provided as feedback, via output port 112D, to combiner 106. Coupler 110 is provided with a coupling ratio which determines the amount of stimulated radiation provided to output port 112C and to output port 112D. Combiner 106 then combines the stimulated radiation provided from output port 112D and the pump pulse provided from laser diode 104 to doped optical fiber 108.

In general, laser diode 104 provides a pump pulse to doped optical fiber 108 in order to induce a fast build-up of the population inversion of the active atoms or ions in doped optical fiber 108. This build-up continues until the lasing threshold is reached, at which point the produced stimulated radiation begins to circulate in laser cavity 105, via coupler 110 and combiner 106. The stimulated radiation is amplified in doped optical fiber 108 over the course of one or more round trips in laser cavity 105, until the available gain of doped optical fiber 108 is depleted and the cavity radiation intensity falls off. The cavity radiation intensity refers to the intensity of the light circulating inside laser cavity 105. The pumping of doped optical fiber 108 is then terminated, by temporarily switching off laser diode 104, to cease further gain increase and to prevent the generation of subsequent pulses. Switching off laser diode 104 after the available gain of doped optical fiber 108 has been depleted results in the cavity radiation intensity falling off to zero. The build up of the population inversion and the subsequent depletion of the available gain substantially cause the laser light outputted from coupler 110 via output port 112C to be a laser pulse. In the art, this is referred to as gain switching. Once the laser pulse is outputted, laser diode 104 is turned on again to generate the next laser pulse, according to the desired pulse repetition rate. The outputted laser pulse has a pulse width that is shorter than the pulse width of the pump pulse provided by laser diode 104, with its pulse repetition rate being determined by the pulse repetition rate of the pump pulse. The power level and duration of the pump pulse are determined based on the properties of the gain medium as well as the components and the design of the laser cavity. The power level and the duration of the pump pulse are controlled to obtain output pulses of a desired power, pulse width and pulse repetition rate. The output peak power of the outputted laser pulse is on the order of hundreds of milliwatts (mW). The pulse width of the outputted laser pulse is on the order of nanoseconds (ns). In one embodiment of the disclosed technique, when the laser pulse is outputted from coupler 110 via output port 112C, laser diode 104, which is the pump laser, operates at an output power level of zero, i.e., it is turned off, so that the gain fiber is not pumped when the laser pulse is outputted from fiber laser 100. In another embodiment of the disclosed technique, when the laser pulse is outputted from coupler 110 via output port 112C, laser diode 104 operates at an output power level which is sufficiently low to maintain the gain of doped optical fiber 108 below its threshold value, i.e. the gain fiber does not produce sustained stimulated emissions. In general, there is no need to detect when the laser pulse is outputted from output port 112C, as the time required for the laser pulse to be produced in fiber laser 100 can be calculated based on various parameters of fiber laser 100, such as the pump current of laser diode 104 and the pump pulse repetition rate, as is known in the art.

In general, the coupling ratio of coupler 110 is such that a larger portion of the stimulated radiation is outputted from coupler 110 than the portion returned to combiner 106. For example, the coupling ratio may be such that 90% of the stimulated radiation is outputted via output port 112C and 10% is returned via output port 112D. In is noted that other ratio breakdowns are possible. For example, if laser diode 104 is a weak laser diode, i.e., its output peak power is low, then returning a larger portion of the stimulated radiation to the gain fiber can expedite the amplification process and the pulse generation process. The spectral properties of coupler 110, such as the wavelength dependence of its coupling ratio, as well as the emission cross-section spectral line shape of the gain fiber determine the spectral properties of the output laser pulse, such as its wavelength and linewidth. Coupler 110 may be custom designed to provide the laser pulse returned to laser cavity 105 via output port 112D with specific spectral properties, such as a particular central wavelength, a particular spectral width and a particular extinction ratio. In general, these spectral properties determine the spectral properties of the outputted laser pulse. It is noted that a plurality of different wavelengths can be generated for the outputted laser pulse of a given doped optical fiber according to the emission cross-section spectral line of its gain medium. For example, the outputted pulse of a Yb-doped laser may have a wavelength ranging from 1030 nanometers (nm) to 1080 nm. It is noted that in this embodiment, no fiber Bragg gratings (FBG) are used, which results in fiber laser 100 being quieter during operation and which increases the operational stability of fiber laser 100 between outputted pulses.

In general, the following parameters are specified according to the desired effect on the power, pulse shape and pulse width of the output laser pulse: the amount of doping and the core size of doped optical fiber 108, the coupling ratio of coupler 110 and the length of laser cavity 105. The length of laser cavity 105 includes the length of doped optical fiber 108 as well as the passive optical fibers which couple doped optical fiber 108 with coupler 110 and combiner 106, and which couple coupler 110 with combiner 106. Passive optical fibers refer to optical fibers which not are doped. In general, except for doped optical fiber 108, all optical fibers in fiber laser 100 are passive optical fibers. According to the disclosed technique, the output peak power of laser diode 104 and the duration of the pump pulses are adjusted and fine-tuned in order to specify a particular output peak power and particular pulse duration of the output laser pulse. The output peak power and the duration of the pump pulses are also determined such that subsequent pulses, except for the desired output laser pulse, are not generated. Other parameters that affect the output peak power and the pulse duration of the output laser pulse include the particular shape of the laser pulse of laser diode 104 as well as the repetition rate at which the laser pulse of laser diode 104 is provided.

Reference is now made to FIG. 1B, which is a schematic illustration showing a pulsed fiber laser setup including a plurality of laser pumps, generally referenced 130, constructed and operative in accordance with another embodiment of the disclosed technique. Fiber laser 130 includes a first electronic driver 132A, a second electronic driver 132B, a first laser diode 134A, a second laser diode 134B and a laser cavity 135. Laser cavity 135 includes a first combiner 136A, a second combiner 136B, a doped optical fiber 138 and a coupler 140. Coupler 140 includes two input ports 142A and 142B and two output ports 142C and 142D. First electronic driver 132A is coupled with first laser diode 134A. Second electronic driver 132B is coupled with second laser diode 134B. First laser diode 134A is coupled with laser cavity 135 via first combiner 136A. Second laser diode 134B is coupled with laser cavity 135 via second combiner 136B. First combiner 136A is coupled with second combiner 136B via doped optical fiber 138. Second combiner 136B is coupled with coupler 140 via input port 142A. In this embodiment of the disclosed technique, input port 142B is not coupled with another element or component. In other embodiments of the disclosed technique, such as in the embodiment described below in FIG. 2C, input port 142B is coupled with another element. Coupler 140 is also coupled with first combiner 136A via output port 142D. Output port 142C outputs the laser light produced by fiber laser 130. Output port 142C can be coupled with an output fiber (not shown). Doped optical fiber 138 can also be referred to as a gain fiber. In general, the components of fiber laser 130 are substantially similar to the components of fiber laser 100 (FIG. 1A). Except for doped optical fiber 138, all other optical fibers in fiber laser 130 are passive optical fibers.

In fiber laser 130, doped optical fiber 138 is pumped by two laser diodes, first laser diode 134A and second laser diode 134B. It is noted that doped optical fiber 138 can also be pumped by a plurality of laser diodes (not shown), which can be combined by a standard pump combiner or, alternatively, can each be coupled with the gain fiber individually. In one embodiment, first laser diode 134A and second laser diode 134B pump doped optical fiber 138 simultaneously. In another embodiment, a delay in time is placed on one of the laser diodes such that first laser diode 134A and second laser diode 134B do not pump doped optical fiber 138 at the same time. It is noted that each of the electronic drivers provide respective diode drive signals to their respective laser diodes. In general, the various parameters specifying first electronic driver 132A and second electronic driver 132B as well as the various parameters specifying first laser diode 134A and second laser diode 134B can be substantially similar or different. For example, the laser diodes may pump doped optical fiber 138 with the same output peak power or with different output peak powers. Also, the duration of time each electronic driver operates its respective laser diode may be the same or may differ. In general, different diode drive signals may be combined to achieve a desired pump pulse shape. Furthermore, one of the laser diodes may be operated in a CW mode at a low output power level as a laser bias, while the other laser diode operates as a laser pump. Operating one of the laser diodes in a CW mode may expedite the population inversion of the active atoms or ions in doped optical fiber 138. For example, electronic driver 132A may operate laser diode 134A in a CW mode at an output power level which is sufficiently low to maintain the gain of doped optical fiber 138 below its threshold value, whereas electronic driver 132B may operate laser diode 134B in a pulsed mode for pumping doped optical fiber 138. In this example, laser diodes 134A and 134B can be of lower output peak power. It is noted that in an embodiment where a plurality of laser diodes are provided to pump doped optical fiber 138, at least one of the laser diodes may be operated in a CW mode as a laser bias, whereas at least another one of the laser diodes may be operated in a pulsed mode for pumping the gain fiber.

Reference is now made to FIG. 2A which is a schematic illustration showing a pulsed fiber laser setup including an isolator, generally referenced 170, constructed and operative in accordance with a further embodiment of the disclosed technique. Fiber laser 170 includes an electronic driver 172, a laser diode 174 and a laser cavity 175. Laser cavity 175 includes a combiner 176, an isolator 178, a coupler 180 and a doped optical fiber 184. Coupler 180 includes two input ports 182A and 182B and two output ports 182C and 182D. Electronic driver 172 is coupled with laser diode 174. Laser diode 174 is coupled with laser cavity 175 via combiner 176. Combiner 176 is coupled with isolator 178 via doped optical fiber 184. Coupler 180 is coupled with combiner 176 via output port 182D. It is noted that coupler 180 can have a standard 2×2 port configuration. Coupler 180 can also have a 2×1 port configuration. In such a configuration, coupler 180 would have one input port and two output ports, with the input port being coupled with the isolator, one of the output ports being coupled with the combiner and the other output port being used for outputting the laser pulse produced by fiber laser 170. Output port 182C outputs the laser light produced by fiber laser 170. Output port 182C can be coupled with an output fiber (not shown). Doped optical fiber 184 can also be referred to as a gain fiber. Isolator 178 can be embodied a free space device. Isolator 178 can also be embodied as a Faraday rotator. In general, the components of fiber laser 170 are substantially similar to the components of fiber laser 100 (FIG. 1A).

In fiber laser 170, isolator 178 enables the stimulated radiation produced in doped optical fiber 184 to propagate in only one direction, thereby causing uni-directional lasing in laser cavity 175 and increasing the output power of the outputted laser pulse. The direction of propagation enabled by isolator 178 corresponds to the direction of propagation of laser light through coupler 180, depicted in FIG. 2A as an arrow 186. In general, isolator 178 may be placed anywhere inside laser cavity 175, for example, between coupler 180 and combiner 176. It is noted that without isolator 178, in general, bi-directional lasing may occur in laser cavity 175. In bi-directional lasing, two laser pulses are generated which circulate in the laser cavity. One laser pulse would be outputted via output port 182C whereas the other laser pulse would be provided to input port 182B. The laser pulse provided to input port 182B could be detected by a sensor (not shown) and used to monitor the laser pulses and stimulated radiation in laser cavity 175. It is noted though that bi-directional lasing is less efficient than uni-directional lasing in terms of the output power of the outputted laser pulse, since in uni-directional lasing, all the stimulated radiation in the laser cavity is used to produce the laser pulse.

Reference is now made to FIG. 2B, which is a schematic illustration showing a pulsed fiber laser setup including a band pass filter, generally referenced 210, constructed and operative in accordance with another embodiment of the disclosed technique. Fiber laser 210 includes an electronic driver 212, a laser diode 214 and a laser cavity 215. Laser cavity 215 includes a combiner 216, a band pass filter (BPF) 218, a doped optical fiber 220 and a coupler 222. Coupler 222 includes two input ports 224A and 224B and two output ports 224C and 224D. Electronic driver 212 is coupled with laser diode 214. Laser diode 214 is coupled with laser cavity 215 via combiner 216. Combiner 216 is coupled with BPF 218 via doped optical fiber 220. Coupler 222 is coupled with combiner 216 via output port 224D. It is noted that coupler 222 can have a standard 2×2 port configuration. Output port 224C outputs the laser light produced by fiber laser 210. Output port 224C can be coupled with an output fiber (not shown). BPF 218 can be a filter with a constant pass band or a tunable filter with a variable pass band. BPF 218 can also be embodied as a FBG (fiber Bragg grating) transmission filter. In general, the components of fiber laser 210 are substantially similar to the components of fiber laser 100 (FIG. 1A).

It is noted that fiber laser 210 can include an isolator (not shown) substantially similar to isolator 178 (FIG. 2A). BPF 218 may be placed anywhere inside laser cavity 215, for example, between coupler 222 and combiner 216. BPF 218 can also be integrated with other intra-cavity components, such as an isolator (not shown). In general, BPF 218 can be used to determine the spectral properties of the outputted laser beam. For example, BFP 218 may have a specified central wavelength, which is either tunable or constant, as well as a particular spectral response, either of which can determine the wavelength of the lasing radiation, i.e. the laser pulse circulating inside laser cavity 215. The wavelength of the lasing radiation essentially determines the wavelength of the outputted laser pulse.

Reference is now made to FIG. 2C, which is a schematic illustration showing a pulsed fiber laser setup including a band pass filter and a reflective mirror, generally referenced 250, constructed and operative in accordance with a further embodiment of the disclosed technique. Fiber laser 250 includes an electronic driver 252, a laser diode 254 and a laser cavity 255. Laser cavity 255 includes a combiner 256, a fiber Bragg grating (FBG) 260, a doped optical fiber 258 and a coupler 262. It is noted that FBG 260 is a type of reflective band pass filter. In other words, FBG 260 is substantially a band pass filter coupled with a reflective mirror. It is also noted that FBG 260 could be replaced with any type of band pass filter coupled with a reflective mirror. Coupler 262 includes two input ports 264A and 264B and two output ports 264C and 264D. Electronic driver 252 is coupled with laser diode 254. Laser diode 254 is coupled with laser cavity 255 via combiner 256. Combiner 256 is coupled with coupler 262 via doped optical fiber 258. Coupler 262 is coupled with combiner 256 via output port 264D. Coupler 262 is also coupled with FGB 260 via input port 264B. It is noted that coupler 262 can have a standard 2×2 port configuration. Output port 264C outputs the laser light produced by fiber laser 250. Output port 264C can be coupled with an output fiber (not shown). In general, the components of fiber laser 250 are substantially similar to the components of fiber laser 100 (FIG. 1A).

It is noted that fiber laser 250 can include an isolator (not shown) substantially similar to isolator 178 (FIG. 2A). In general, FBG 260 can be used to determine the spectral properties of the outputted laser pulse, as a portion of the laser pulse circulating inside laser cavity 255 may be provided to FBG 260 via coupler 262 and then reflected back to coupler 262. FBG 260 may have a specified central wavelength, which is either tunable or constant, as well as a particular spectral response. Laser pulses which are provided to FBG 260 are reflected back to coupler 262 at specific wavelengths according to the specified central wavelength, the spectral response, or both of FBG 260. This increases the portion of stimulated radiation in laser cavity 255 having a particular wavelength, thereby determining the wavelength of the laser radiation circulating inside laser cavity 255. It is noted that the optimal amount of reflected laser radiation provided to coupler 262 via FBG 260 may vary according to various parameters of fiber laser 250 and may be tweaked to achieve stable operation of fiber laser 250.

Reference is now made to FIG. 2D, which is a schematic illustration showing a pulsed fiber laser setup including a circulator and a fiber Bragg grating, generally referenced 290, constructed and operative in accordance with another embodiment of the disclosed technique. Fiber laser 290 includes an electronic driver 292, a laser diode 294 and a laser cavity 295. Laser cavity 295 includes a combiner 296, a circulator 300, a doped optical fiber 298 and a fiber Bragg grating (FBG) 302. Electronic driver 292 is coupled with laser diode 294. Laser diode 294 is coupled with laser cavity 295 via combiner 296. Combiner 296 is coupled with circulator 300 via doped optical fiber 298. Circulator 300 is coupled with combiner 296. Circulator 300 is also coupled with FGB 302. FBG 302 outputs the laser light produced by fiber laser 290. FBG 302 can be coupled with an output fiber (not shown). In general, the components of fiber laser 290 are substantially similar to the components of fiber laser 100 (FIG. 1A).

In fiber laser 290, uni-directional lasing is achieved via circulator 300 and FBG 302. Laser radiation provided to combiner 296 is provided to circulator 300, via doped optical fiber 298. Circulator 300 transfers the laser radiation to FBG 302, which reflects a portion of it back to circulator 300 while the rest is outputted as a laser pulse. Circulator 300 then provides the reflected laser radiation back to combiner 296. In this respect, uni-directional lasing is achieved in fiber laser 290. In general, FBG 302 can be used to determine the spectral properties of the outputted laser pulse, as a portion of the laser radiation circulating inside laser cavity 295 is provided to FBG 302. FBG 302 may have a specified central wavelength, which is either tunable or constant, as well as a particular spectral response. Laser radiation, which is provided to FBG 302, is reflected back to circulator 300 at specific wavelengths according to the specified central wavelength, the spectral response, or both of FBG 302. This increases the portion of laser radiation in laser cavity 295 having a particular wavelength, thereby determining the wavelength of the laser pulse circulating inside laser cavity 295. It is noted that the optimal amount of reflected laser radiation provided to circulator 300 via FBG 302, may vary according to various parameters of fiber laser 290. In general, the portion of laser light reflected from FBG 302 back to circulator 300 is small to enable a greater portion of the laser radiation circulating inside the cavity to be outputted as the laser pulse. It is noted that in another embodiment, FBG 302 may be replaced by an optical fiber mirror (not shown). The optical fiber mirror may include a selective wavelength optical coating. The optical coating may be anti-reflective. In such an embodiment, fiber laser 290 may also include a band pass filter (not shown), coupled between circulator 300 and the optical fiber mirror.

Reference is now made to FIG. 2E, which is a schematic illustration showing a pulsed fiber laser setup including two fiber Bragg gratings, generally referenced 330, constructed and operative in accordance with a further embodiment of the disclosed technique. Fiber laser 330 includes an electronic driver 332, a laser diode 334 and a laser cavity 335. Laser cavity 335 includes a high reflection fiber Bragg grating (HRFBG) 336, a combiner 337, a doped optical fiber 338, a passive optical fiber 339 and a low reflection fiber Bragg grating (LRFBG) 340. LRFBG 340 can also be referred to as a coupling mirror. It is noted that a coupling mirror can be substituted for LRFBG 340. Electronic driver 332 is coupled with laser diode 334. Laser diode 334 is coupled with laser cavity 335 via combiner 337. Combiner 337 is coupled with HRFBG 336 via passive optical fiber 339. Combiner 337 is also coupled with LRFBG 340 via doped optical fiber 338. LRFBG 340 outputs the laser light produced by fiber laser 330. LRFBG 340 can be coupled with an output fiber (not shown). In general, the components of fiber laser 330 are substantially similar to the components of fiber laser 100 (FIG. 1A).

Laser cavity 335 is formed via HRFBG 336, combiner 337 and LRFBG 340. Both HRFBG 336 and LRFBG 340 are used to determine the spectral properties of the outputted laser pulse. In general, both HRFBG 336 and LRFBG 340 have substantially similar specified central wavelengths, which are either tunable or constant, as well as substantially similar spectral widths and linewidths. Laser pulses are provided to combiner 337, which provides the laser pulses to HRFBG 336. The laser pulses are then reflected in HRFBG 336 and provided to LRFBG 340 via combiner 337 and doped optical fiber 338. Laser pulses which are provided to HRFBG 336 are provided to LRFBG 340. LRFBG 340 reflects back a portion of the laser pulses to HRFBG 336, via combiner 337, at specific wavelengths according to at least one of the specified central wavelength, the spectral response, or the linewidth of the fiber Bragg gratings in fiber laser 330. This increases the portion of laser radiation in laser cavity 335 having a particular wavelength, thereby determining the wavelength of the outputted laser pulse.

Reference is now made to FIG. 2F, which is a schematic illustration showing a pulsed fiber laser setup including a saturable absorber, generally referenced 360, constructed and operative in accordance with another embodiment of the disclosed technique. Fiber laser 360 includes an electronic driver 362, a laser diode 364 and a laser cavity 365. Laser cavity 365 includes a combiner 366, a saturable absorber 370, a doped optical fiber 368 and a coupler 372. Coupler 372 includes two input ports 374A and 374B and two output ports 374C and 374D. Electronic driver 362 is coupled with laser diode 364. Laser diode 364 is coupled with laser cavity 365 via combiner 366. Combiner 366 is coupled with saturable absorber 370 via doped optical fiber 368. Saturable absorber 370 is coupled with coupler 372 via input port 374A. Coupler 372 is coupled with combiner 366 via output 374D. Coupler 372 outputs the laser light produced by fiber laser 360 via output port 374C. Coupler 372 can be coupled with an output fiber (not shown). Input port 374B is not coupled with another element or component. In general, the components of fiber laser 360 are substantially similar to the components of fiber laser 100 (FIG. 1A).

Saturable absorber 370 may be positioned anywhere inside laser cavity 365, for example, between coupler 372 and combiner 366. It is noted that saturable absorber 370 may be positioned and used in any of the embodiments described above in FIGS. 2A to 2E. Saturable absorber 370 may be a free space device. Saturable absorber 370 may be embodied using various known techniques. For example, saturable absorber 370 may be doped crystals such as Cr:YAG, CO:ZnSe or V:YAG, quantum dots doped glasses such as PbS (lead sulfide) or rare-earth doped fibers such as Chromium-doped (Cr-doped) fibers, Samarium-doped (Sm-doped) fibers or Thulium-doped (Tm-doped) fibers. Saturable absorber 370 can also be embodied as a semiconductor saturable absorber mirror (SESAM). If saturable absorber 370 is embodied as an absorber mirror, such as a SESAM, and it is used in a fiber laser setup which includes a high reflectivity reflector, such as in fiber laser 330 (FIG. 2E), then the saturable absorber can replace the high reflectivity reflector. For example, in fiber laser 330, if a saturable absorber is included, it could replace high reflection fiber Bragg grating 336 (FIG. 2E).

The properties of saturable absorber 370 that affect the formation of the laser pulse include: initial transmittance value, saturation fluence and modulation depth. Initial transmittance value is a measure of how much of the laser radiation in laser cavity 365 can initially pass through saturable absorber 370. Saturation fluence refers to the fluence (i.e., energy per unit area) it takes to reduce the initial value of the fluence to 1/e of its initial value, where e is the base of the natural logarithm. Modulation depth refers to the maximum amount of change in optical losses. The selected values of the initial transmission value, saturation fluence and modulation depth of saturable absorber 370 are adjusted and fine-tuned depending on the desired effect on the outputted laser pulse, such as an increase in its power and a decrease in its width. In addition, the absorption spectrum of saturable absorber 370 should substantially correspond to the wavelength of the stimulated radiation circulating in laser cavity 365. Furthermore, the absorption cross-section of saturable absorber 370 should be higher than the emission cross-section of doped optical fiber 368 at the wavelength of the stimulated radiation circulating in laser cavity 365, so that saturable absorber 370, as described below, can increase the lasing threshold of fiber laser 360. Also, the saturation recovery time of saturable absorber 370 should be on the order of magnitude of the desired pulse width of the outputted laser beam. The saturation recovery time can also be longer than the desired pulse width of the outputted laser beam, but shorter than the time between consecutive pump pulses.

In the embodiment of FIG. 2F, saturable absorber 370 is used to enhance the performance of the pulsed fiber laser setup of FIG. 2A using a technique similar to passive Q-switching (i.e., by increasing the available gain in fiber laser 360 via the introduction of saturable losses). Laser diode 364 provides pulses of pump energy to doped optical fiber 368 in order to induce a build-up of the population inversion of the active atoms or ions in doped optical fiber 368. Without saturable absorber 370, this build-up would continue until the lasing threshold is reached, at which point the produced stimulated radiation would be amplified while circulating in laser cavity 365, via coupler 372 and combiner 366. With the inclusion of saturable absorber 370 in this embodiment, as the gain reaches the level corresponding to the lasing threshold of the laser without the saturable absorber, the stimulated radiation in laser cavity 365 continues to be partially absorbed by saturable absorber 370, thereby enabling laser diode 364 to provide additional energy to doped optical fiber 368. In other words, saturable absorber 370 enables the lasing threshold of fiber laser 360 to be increased. Saturable absorber 370 continues to absorb stimulated radiation until its capacity for absorption, i.e. its saturation point, is reached, at which point saturable absorber 370 is said to be bleached. As the saturation point of saturable absorber 370 is reached, the stimulated radiation circulating in laser cavity 365 is amplified rapidly and the available gain of doped optical fiber 368 is depleted, thereby generating a laser pulse, which is outputted via output port 374C of coupler 372. Due to the saturable absorber, the available gain in fiber laser 360 is higher than the available gain in a fiber laser without a saturable absorber. The increase in available gain results in an outputted laser pulse having a higher output power and also having a shorter pulse width as compared to the output power and pulse width of an outputted laser pulse from a fiber laser not including a saturable absorber. It is noted that in this embodiment, the saturable absorber is used to enhance the outputted pulse power and decrease the pulse width which, along with the pulse repetition rate, are substantially determined by the pump pulse power and duration. As such, the outputted pulse properties can be controlled to a higher degree as compared to the passive Q-switching methods known in the art.

Reference is now made to FIG. 2G, which is a schematic illustration showing a pulsed fiber laser setup including an electronic controller, generally referenced 400, constructed and operative in accordance with a further embodiment of the disclosed technique. Fiber laser 400 includes a first electronic driver 402, a laser diode 404, a laser cavity 405, a tuner 410 and a second electronic driver 411. Laser cavity 405 includes a high reflection fiber Bragg grating (HRFBG) 406, a combiner 407, a doped optical fiber 408, a passive optical fiber 409 and a low reflection fiber Bragg grating (LRFBG) 412. LRFBG 412 can also be referred to as a coupling mirror. First electronic driver 402 is coupled with laser diode 404. Laser diode 404 is coupled with laser cavity 405 via combiner 407. Combiner 407 is coupled with LRFBG 412, via doped optical fiber 408. Combiner 407 is also coupled with HRFBG 406 via passive optical fiber 409. HRFBG 406 is coupled with tuner 410. Second electronic driver 411 is coupled with tuner 410. LRFBG 412 outputs the laser light produced by fiber laser 400. LRFBG 412 can be coupled with an output fiber (not shown). It is noted that in another embodiment, the tuner is coupled with the LRFBG. In a further embodiment, the tuner is coupled with both the HRFBG and the LRFBG. Both HRFBG 406 and LRFBG 412 have substantially similar specified central wavelengths, at least one of which is tunable, as well as substantially similar spectral widths. In general, the components of fiber laser 400 are substantially similar to the components of fiber laser 100 (FIG. 1A) and fiber laser 330 (FIG. 2E).

In the embodiment of FIG. 2G, tuner 410 is used to enhance the performance of the pulsed fiber laser setup of FIG. 2A by means of a technique similar to active Q-switching (i.e., by increasing the available gain in fiber laser 400 via the introduction of controllable losses). In general, as shown in the setup of fiber laser 400 (FIG. 2G), laser diode 404 provides pump pulses to combiner 407, thereby causing a build-up of the population inversion of the active atoms or ions in doped optical fiber 408. The laser radiation in laser cavity 405 reflects back and forth between HRFBG 406 and LRFBG 412, via combiner 407, at specific wavelengths according to the specified central wavelength, the spectral response or both of the fiber Bragg gratings (HRFBG 406 and LRFBG 412) in fiber laser 400. This build-up continues until the lasing threshold is reached, at which point stimulated radiation is amplified and the formed laser pulse is outputted via LRFBG 412. The gain of doped optical fiber 408 can be increased by using tuner 410, as described below. By increasing the gain of doped optical fiber 408, the output power of the outputted laser pulse can be increase significantly. Also, the pulse width of the outputted laser pulse can be further reduced.

In general, fiber Bragg gratings enable radiation to be reflected to varying degrees in particular wavelength regions. For example, HRFBG 406 reflects substantially all radiation impinging on it having a wavelength similar to its specified central wavelength, whereas LRFBG 412 reflects only a portion of the radiation impinging on it having a wavelength similar to its specified central wavelength. Tuner 410 enables the specified central wavelength of a fiber Bragg grating to be slightly shifted. In fiber laser 400, second electronic driver 411 causes tuner 410 to slightly shift the specified central wavelength of HRFBG 406 synchronously with the pump pulses provided by laser diode 404 to laser cavity 405. It is noted that the operation of first electronic driver 402 and second electronic driver 411 is synchronized. The specified central wavelength of HRFBG 406 is shifted sufficiently such that the wavelengths at which HRFBG 406 and LRFBG 412 reflect at do not fully overlap, thereby causing losses in laser cavity 405. In other words, laser radiation is not reflected back and forth between the two fiber Bragg gratings as they now reflect at different wavelengths. As losses in the cavity occur, laser diode 404 can provide more energy to laser cavity 405, thereby increasing the population inversion of doped optical fiber 408 before the lasing threshold of fiber laser 400 is reached, i.e., increasing the lasing threshold of fiber laser 400. Once a desired increased population inversion is achieved, tuner 410 can be used to shift the specified central wavelength of HRFBG 406 back to its initial value such that laser radiation reflects back and forth in laser cavity 405, thereby causing optical feedback in laser cavity 405. Due to the optical feedback, the stimulated radiation is rapidly amplified and the gain of doped optical fiber 408 is depleted thereby causing the generation of a laser pulse which is outputted via LRFBG 412. The outputted pulse has a higher power and shorter pulse width as compared to an outputted pulse generated in the setup of FIG. 2G with constant reflection, as in fiber laser 330 (FIG. 2E). It is noted that the amount of achievable population inversion is limited by the maximum possible stored energy in a given gain fiber, as is known in the art.

Tuner 410 can be embodied as a piezoelectric or magneto-mechanic actuator. In such an embodiment, HRFBG 406 includes a strain which can be induced by the actuator, resulting in a physical change in the length of HRFBG 406 due to pressure. The length change alters the reflection spectrum of HRFBG 406, shifting its central wavelength. Tuner 410 can also be embodied as a thermo-electric cooler, which can result in a physical change in the length of HRFBG 406 due to variations in temperature. Tuner 410 is controlled by second electronic driver 411 and can be controlled by any pulse shape from second electronic driver 411 to repetitively prevent overlap of the wavelengths at which the fiber Bragg gratings reflect.

Reference is now made to FIG. 2H, which is a schematic illustration showing a pulsed fiber laser setup including an optical fiber mirror and a coupler, generally referenced 500, constructed and operative in accordance with another embodiment of the disclosed technique. Fiber laser 500 includes an electronic driver 502, a laser diode 504 and a laser cavity 505. Laser cavity 505 includes a combiner 506, an optical fiber mirror 508, a doped optical fiber 510, a coupler 512 and a passive optical fiber 514. Electronic driver 502 is coupled with laser diode 504. Laser diode 504 is coupled with laser cavity 505 via combiner 506. Combiner 506 is coupled with optical fiber mirror 508 via passive optical fiber 514. Combiner 506 is also coupled with coupler 512 via doped optical fiber 510. Coupler 512 can be coupled with an output fiber (not shown). It is noted that coupler 512 may have a standard 2×2 port configuration. Coupler 512 may be referred to as a coupling mirror. It is also noted that one input port of coupler 512 is coupled with doped optical fiber 510, whereas the other input port of coupler 512 is used to output the laser light produced by fiber laser 500. The two output ports of coupler 512 are coupled with one another, as shown in FIG. 2H in a section 516. In general, the components of fiber laser 500 are substantially similar to the components of fiber laser 100 (FIG. 1A).

Laser cavity 505 is formed via optical fiber mirror 508, combiner 506 and coupler 512. The spectral properties of the outputted laser pulse are determined by either the spectral properties of optical fiber mirror 508, the spectral properties of coupler 512 or both. Optical fiber mirror 508 can include, for example, a fiber pigtailed collimator and a mirror. The collimator may have an anti-reflective optical coating to reduce transmission losses and the mirror may be an optically coated glass surface or metal surface, for example. In such a case, the spectral properties of the optical fiber mirror will be defined by the combined spectral properties of the collimator, the collimator coating, the mirror and the mirror coating. The spectral properties of coupler 512 are similar to the spectral properties of coupler 110 (FIG. 1A) as described above. In general, the spectral properties of an optical fiber mirror may include a very wide pass band, therefore, in order to define the spectral properties of optical fiber mirror 508 more specifically, the mirror in optical fiber mirror 508 can be coated with a selective wavelength optical coating. The optical coating may be anti-reflective. In addition, an optional band pass filter may be coupled in between combiner 506 and optical fiber mirror 508. It is noted that in another embodiment of the disclosed technique, optical fiber mirror 508 can be replaced by an HRFBG (not shown). It is noted that in a further embodiment of the disclosed technique, coupler 512 can be replaced by an LRFBG (not shown). In either of such embodiments, the spectral properties of the HRFBG or the LRFBG can be used to define the spectral properties of the outputted laser light more specifically.

In fiber laser 500, electronic driver 502 operates laser diode 504 by providing laser diode 504 with a drive current. Laser diode 504 then provides pump pulses to combiner 506, which provides the pump pulses to doped optical fiber 510 which generates laser pulses. The laser pulses are reflected in coupler 512 and are provided back to doped optical fiber 510 and then to optical fiber mirror 508. Optical fiber mirror 508 reflects the received laser pulses and provides the reflected laser pulses to coupler 512 via doped optical fiber 510. The output ports of coupler 512, as shown in section 516, reflect a portion of the laser pulses back to optical fiber mirror 508, via doped optical fiber 510 and combiner 506, whereas another portion of the laser pulses are outputted as laser light via the second input port of coupler 512. Laser pulses are substantially reflected between optical fiber mirror 508 and coupler 512 until the lasing threshold is reached, at which point laser light is outputted by one of the input ports of coupler 512.

FIG. 3 is a schematic illustration showing a pulsed fiber laser setup including a fiber amplifier, generally referenced 430, constructed and operative in accordance with a further embodiment of the disclosed technique. Pulsed fiber laser setup 430 includes a fiber laser 432, an isolator 434 and an amplifier 436. Fiber laser 432 is coupled with isolator 434, which is coupled in turn with amplifier 436. Isolator 434 is an optional component. For example, fiber laser 432 can be any of the fiber lasers shown above in the embodiments of FIGS. 2A to 2G. In general, fiber laser 432 generates a laser pulse which is provided to isolator 434.

Isolator 434 provides the laser pulse to amplifier 436 which amplifies the laser pulse, thereby increasing its power. Amplifier 436 may include a plurality of amplification stages. Amplifier 436 can be constructed to amplify laser pulses only at the wavelength of the outputted laser pulses of fiber laser 432.

It will be appreciated by persons skilled in the art that the disclosed technique is not limited to what has been particularly shown and described hereinabove. Rather the scope of the disclosed technique is defined only by the claims, which follow.

1. Pulsed fiber laser, comprising:
an electronic driver, for providing a drive current;
a laser diode, coupled with said electronic driver, for generating a pump pulse; and
a laser cavity;
said laser cavity comprising:
a combiner, coupled with said laser diode;
a doped optical fiber, coupled with said combiner, for absorbing said pump pulse and for generating a circulating laser pulse; and
a coupler, coupled with said doped optical fiber and said combiner, for outputting a first portion of said circulating laser pulse and for returning a second portion of said circulating laser pulse to said combiner,
wherein said electronic driver operates said laser diode at a specific pump pulse repetition rate (PRR), a specific pump pulse shape and a specific pump pulse width; and
wherein said combiner provides said pump pulse and said second portion of said circulating laser pulse to said doped optical fiber.

2. (canceled)

3. The pulsed fiber laser according to claim 1, wherein said combiner is a pump coupler.

4. (canceled)

5. The pulsed fiber laser according to claim 1, wherein said doped optical fiber is doped with an active, rare earth element selected from the list consisting of:
Ytterbium;
Erbium;
Erbium Ytterbium;
Thulium;
Neodymium; and
Germanium.

6. The pulsed fiber laser according to claim 1, wherein said doped optical fiber is a double clad fiber having a single mode core.

7. The pulsed fiber laser according to claim 1, wherein said doped optical fiber is a single clad fiber.

8. The pulsed fiber laser according to claim 7, wherein said combiner is substituted for a wavelength division multiplexing (WDM) coupler.

9. (canceled)

10. The pulsed fiber laser according to claim 1, wherein said coupler has a standard 2×2 port configuration.

11-15. (canceled)

16. The pulsed fiber laser according to claim 1, wherein said specific pump PRR is on the order of tens of kilohertz.

17-18. (canceled)

19. The pulsed fiber laser according to claim 1, wherein when said coupler outputs said first portion of said circulating laser pulse, an output power level of said laser diode is zero.

20. The pulsed fiber laser according to claim 1, wherein when said coupler outputs said first portion of said circulating laser pulse, an output power level of said laser diode is sufficiently low to maintain a gain of said doped optical fiber below a threshold value.

21. The pulsed fiber laser according to claim 1, wherein properties of said first portion of said circulating laser pulse are determined by parameters selected from the list consisting of:
the amount of doping of said doped optical fiber;
the core size of said doped optical fiber;
the emission cross section spectral line shape of said doped optical fiber;
a coupling ratio of said coupler;
said specific pump PRR;
said specific pump pulse shape; and
the length of said laser cavity.

22. The pulsed fiber laser according to claim 1, further comprising an isolator, coupled between said doped optical fiber and said coupler, for enabling uni directional lasing of said circulating laser pulse in said laser cavity.

23-24. (canceled)

25. The pulsed fiber laser according to claim 22, wherein said isolator is coupled between said coupler and said combiner.

26. The pulsed fiber laser according to claim 22, wherein said isolator is coupled between said combiner and said doped optical fiber.

27. The pulsed fiber laser according to claim 1, further comprising a band pass filter, coupled between said doped optical fiber and said coupler, for determining spectral properties of said circulating laser pulse.

28. (canceled)

29. The pulsed fiber laser according to claim 27, wherein said band pass filter comprises a tunable filter with a variable pass band.

30. The pulsed fiber laser according to claim 27, wherein said band pass filter is a fiber Bragg grating transmission filter.

31. The pulsed fiber laser according to claim 27, wherein said band pass filter is coupled between said coupler and said combiner.

32. The pulsed fiber laser according to claim 27, wherein said band pass filter is coupled between said combiner and said doped optical fiber.

33-35. (canceled)

36. The pulsed fiber laser according to claim 1, further comprising a fiber Bragg grating, coupled with said coupler, for determining spectral properties of said circulating laser pulse.

37. The pulsed fiber laser according to claim 36, wherein said fiber Bragg grating is substituted for a band pass filter coupled with a reflective mirror.

38-41. (canceled)

42. The pulsed fiber laser according to claim 1, further comprising a saturable absorber, coupled between said doped optical fiber and said coupler, for increasing the available gain in said pulsed fiber laser.

43. The pulsed fiber laser according to claim 42, wherein said saturable absorber is coupled between said coupler and said combiner.

44. The pulsed fiber laser according to claim 42, wherein said saturable absorber is coupled between said combiner and said doped optical fiber.

45. The pulsed fiber laser according to claim 42, wherein said saturable absorber is selected from the list consisting of:
a free space device;
Cr:YAG doped crystals;
CO:ZnSe doped crystals;
V:YAG doped crystals;
PbS quantum dots doped glass;
Chromium doped fibers;
Samarium doped fibers;
Thulium doped fibers; and
a semiconductor saturable absorber mirror.

46-53. (canceled)

54. The pulsed fiber laser according to claim 1, further comprising an amplifier, coupled with said coupler, for amplifying said first portion of said circulating laser pulse.

55. The pulsed fiber laser according to claim 54, wherein said amplifier comprises a plurality of amplification stages.

56. (canceled)

57. The pulsed fiber laser according to claim 54, further comprising an isolator, coupled between said coupler and said amplifier.

58-59. (canceled)

60. Pulsed fiber laser, comprising:
an electronic driver, for providing a drive current;
a laser diode, coupled with said electronic driver, for generating a pump pulse; and
a laser cavity;
said laser cavity comprising:
a doped optical fiber, coupled with said laser diode, for absorbing said pump pulse and for generating a circulating laser pulse; and
a coupler, coupled with a first side of said doped optical fiber and a second side of said doped optical fiber, for outputting a first portion of said circulating laser pulse and for returning a second portion of said circulating laser pulse to said second side of said doped optical fiber,
wherein said electronic driver operates said laser diode at a specific pump pulse repetition rate (PRR), a specific pump pulse shape and a specific pump pulse width; and
wherein said pump pulse and said second portion of said circulating laser pulse are provided to said second side of said doped optical fiber.

61. Pulsed fiber laser, comprising:
a plurality of electronic drivers, each one of said plurality of electronic drivers for providing a respective drive current;
a plurality of laser diodes, each one of said plurality of laser diodes coupled with a respective one of said plurality of electronic drivers, each one of said plurality of laser diodes for generating a respective pump pulse; and
a laser cavity;
said laser cavity comprising:
a plurality of combiners, each one of said plurality of combiners coupled with a respective one of said plurality of said laser diodes;
a doped optical fiber, coupled with each of said plurality of combiners, for absorbing each of said respective pump pulses and for generating a circulating laser pulse; and
a coupler, coupled with a first one of said plurality of combiners and with a second one of said plurality of combiners, for outputting a first portion of said circulating laser pulse and for returning a second portion of said circulating laser pulse to one of said plurality of combiners,
wherein said plurality of electronic drivers respectively operate said plurality of laser diodes at specific pump pulse repetition rates (PRRs), specific pump pulse widths and specific pulse shapes; and
wherein said plurality of combiners provide said respective pump pulses and said second portion of said circulating laser pulse to said doped optical fiber.

62. (canceled)

63. The pulsed fiber laser according to claim 61, wherein a standard pump combiner is substituted for said plurality of combiners.

64-70. (canceled)

71. Pulsed fiber laser, comprising:
an electronic driver, for providing a drive current;
a laser diode, coupled with said electronic driver, for generating a pump pulse; and
a laser cavity;
said laser cavity comprising:
a combiner, coupled with said laser diode;
a doped optical fiber, coupled with said combiner, for absorbing said pump pulse and for generating a circulating laser pulse;
a circulator, coupled with said doped optical fiber and said combiner; and
a fiber Bragg grating (FBG), coupled with said circulator,
wherein said circulator provides said circulating laser pulse to said FBG,
wherein said FBG outputs a first portion of said circulating laser pulse and returns a second portion of said circulating laser pulse to said circulator,
wherein said circulator provides said second portion of said circulating laser pulse to said combiner;
wherein said electronic driver operates said laser diode at a specific pump pulse repetition rate (PRR), a specific pump pulse width and a specific pump pulse shape; and
wherein said combiner provides said pump pulse and said second portion of said circulating laser pulse to said doped optical fiber.

72. (canceled)

73. The pulsed fiber laser according to claim 71, wherein said FBG is used for determining spectral properties of said first portion of said circulating laser pulse.

74-78. (canceled)

79. The pulsed fiber laser according to claim 71, wherein an optical fiber mirror is substituted for said FBG.

80. The pulsed fiber laser according to claim 79, wherein said optical fiber mirror comprises a selective wavelength optical coating.

81. The pulsed fiber laser according to claim 79, further comprising a band pass filter, coupled in between said optical fiber mirror and said combiner.

82-87. (canceled)

88. Pulsed fiber laser, comprising:
a first electronic driver, for providing a drive current;
a laser diode, coupled with said first electronic driver, for generating a pump pulse; and
a laser cavity;
said laser cavity comprising:
a combiner, coupled with said laser diode;
a doped optical fiber, coupled with said combiner, for absorbing said pump pulse and for generating a circulating laser pulse;
a semiconductor saturable absorber mirror, coupled with said combiner, for reflecting said pump pulse; and
a low reflection fiber Bragg grating (LRFBG), coupled with said doped optical fiber, for outputting a first portion of said circulating laser pulse and for returning a second portion of said circulating laser pulse to said combiner,
wherein said combiner provides said pump pulse and said second portion to said semiconductor saturable absorber mirror; and
wherein said first electronic driver operates said laser diode at a specific pump pulse repetition rate (PRR), specific pump pulse width and a specific pulse shape.

89-91. (canceled)

92. The pulsed fiber laser according to claim 88, further comprising:
a tuner, coupled with at least one of said semiconductor saturable absorber mirror and said LRFBG, for increasing the available gain in said pulsed fiber laser; and
a second electronic driver, coupled with said tuner, for operating said tuner,
wherein said first electronic driver and said second electronic driver are synchronized.

93-107. (canceled)

108. A pulsed fiber laser, comprising:
an electronic driver, for providing a drive current;
a laser diode, coupled with said electronic driver, for generating a pump pulse; and
a laser cavity;
said laser cavity comprising:
a combiner, coupled with said laser diode;
a doped optical fiber, coupled with said combiner, for absorbing said pump pulse and or generating a circulating laser pulse;
an optical fiber mirror, coupled with said combiner, for reflecting said circulating laser pulse; and
a coupler, coupled with said doped optical fiber, for outputting a first portion of said circulating laser pulse and for returning a second portion of said circulating laser pulse to said combiner,
wherein said electronic driver operates said laser diode at a specific pump pulse repetition rate (PRR), specific pump pulse width and a specific pulse shape; and
wherein said combiner provides said pump pulse to said doped optical fiber.
